(19) United States
(12) Patent Application Publication
(10) Pub. No.: US 2023/0286560 A1
(43) Pub. Date: Sep. 14, 2023

(54) BRACKET ASSEMBLY FOR RECEIVING AXLE

(71) Applicant: INVENTOR GADGETS, LLC, Charlestown, RI (US)

(72) Inventors: Michael Nicholas DiMeo, Charlestown, RI (US); Ryann Kilgore, Charlestown, RI (US)

(73) Assignee: INVENTOR GADGETS, LLC, Charlestown, RI (US)

(21) Appl. No.: 17/654,727

(22) Filed: Mar. 14, 2022

(51) Int. Cl. B62B 1/10

(52) U.S. Cl. CPC B62B 1/10

(57) ABSTRACT

A bracket assembly is provided herein. The bracket assembly includes a first projecting element extending from a base and a second projecting element extending from the base. The first projecting element and the second projecting element are separated by a receiving space configured to receive a portion of an axle element.

### FIELD

Embodiments of the disclosure relate to the field of mobility systems. More particularly, embodiments of the disclosure relate to the field of bracket systems that are attachable to traditional immobile objects and methods related thereto.

### BACKGROUND

When spending a day at the beach, a family or group generally has many items that they wish to take with them to the beach. Such items may include towels, chairs, umbrellas, games, lotions and sun screen products, food and beverages, and the like. It is often the situation that transporting the desired items to the beach is inconvenient, and cumbersome. Indeed, it often requires many trips back and forth from a car or hotel room to a particular spot on the beach.

Various mobile devices are known that can aid in such transport. However, such known devices generally comprise either a wheeled cart for transporting non-perishable items, such as towels, chairs, etc., or a wheeled cooler for transporting perishable items, such as food and beverages. Such known devices do not generally include a mobile device that is capable of transporting both non-perishable items as well as perishable items, and such known devices generally do not include a sufficient capacity to transport all, or even most, of the items that a family or group will need for a day-long outing at the beach in a single trip. Rather, a person generally still has to make multiple trips from the originating location, e.g., car or hotel room, to the destination location, e.g., spot at the beach.

An additional drawback to known devices is that such devices generally require a large amount of storage space when not used. Such mobile devices are typically stored in a garage, storage shed or closet when not in use because of the bulk of the devices. Further, these mobile devices take up relatively large amounts of space whenever they are transported for use. This is particularly disadvantageous when the mobile devices are packed into the family car when going on the family vacation at the beach. Because they are so large and bulky, they tend to consume a large portion of the available space in the car, thereby limiting the other items that can be taken on the vacation. In addition to being disadvantageous for consumers, such devices also are less desirable to retailers, who have limited shelf space on which to display goods for sale.

One of the known devices is disclosed in U.S. Pat. No. 6,474,097 to Treppedi et al, which is hereby, incorporated herein by reference. The mobile carrying device of Treppedi comprises a cooler that includes ski runners and wheels in combination to aid in mobility of the cooler. It also includes an extendable, pivoting handle that may be retracted and stored adjacent the cooler. Cargo nets are attached to the top and side of the cooler for storage of supplies such as towels, plates and cups. The mobile cooler also includes a retainer attached to a side of the cooler for holding an umbrella.

Another known device is disclosed in U.S. Pat. No. 6,176,499 to Conrado, which is hereby incorporated herein by reference. The mobile carrying device of Conrado is a mobile cooler that includes a cooler body with wheels and a pivoted towing handle having two grips for users of varying heights. The underside of the cooler lid has a recess with a cover panel for storing items separately from other items in the cooler. The cooler includes a table assembly operable independently of the cooler-lid so that the table may be utilized whether the lid is open or closed. The cooler also includes retractable bungee cords for securing items to the cooler.

The devices of Treppedi and Conrado are exemplary of the shortcomings of the known devices previously discussed herein. Accordingly, a need exists for a mobile device that can be used to transport both non-perishable and perishable items and that has enough capacity to transport a sufficient amount of such items for a day at the beach. Moreover, a need exists for a mobile device that is capable of transporting a relatively large number of both perishable and non-perishable items and that has a storage configuration that is substantially smaller in dimensions than its use configuration.

### SUMMARY

Examples of a bracket assembly are provided herein. The bracket assembly includes a first projecting element extending from a base and a second projecting element extending from the base. The first projecting element and the second projecting element are separated by a receiving space configured to receive a portion of an axle element.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a bracket assembly, according to an example of the disclosure;

FIG. 2 illustrates the bracket assembly of FIG. 1 receiving at least a portion of an axle element, according to an example of the disclosure;

FIG. 3 illustrates configuration of a bracket assembly of FIG. 1 attached to a storage device, according to an example of the disclosure;

FIG. 4 illustrates an underside view of the storage device and the placement of multiple bracket assemblies, according to an example of the disclosure;

FIG. 5 illustrates a side view of a storage device with bracket assemblies attached thereto, according to an example of the disclosure;

FIG. 6 is a side view of a storage device, according to an alternative example of the disclosure;

FIG. 7 is a front view of the storage device of FIG. 6 receiving at least a portion of an axle assembly, according to an example of the disclosure; and

FIG. 8 is an side view of the storage device of FIG. 6 receiving at least a portion of the axle assembly, according to an example of the disclosure.

FIG. 9 illustrates an exemplary axle bracket, according to an example of the disclosure.

FIG. 10 illustrates an exemplary axle bracket, according to an alternative example of the disclosure.

FIG. 11 illustrates an exemplary axle bracket, according to an alternative example of the disclosure.

FIG. 12 illustrates an exemplary axle bracket, according to an alternative example of the disclosure.

FIG. 13 illustrates an axle assembly with more than one axle bracket of FIG. 11 mounted thereon, according to an example of the disclosure.

### DETAILED DESCRIPTION

Examples of a bracket assembly are provided herein. The bracket assembly includes a first projecting element extending from a base and a second projecting element extending from the base. The first projecting element and the second projecting element are separated by a receiving space configured to receive a portion of an axle element.

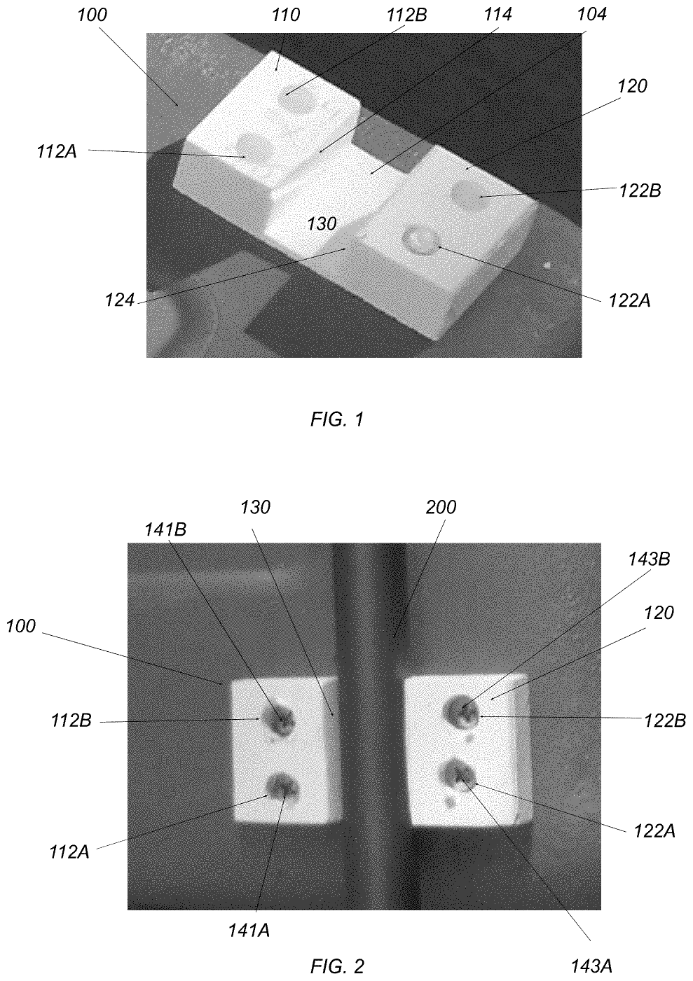

FIG. 1 illustrates a bracket assembly 100, according to an example of the disclosure. The bracket assembly 100 includes a first projecting element 110 and a second projecting element 120, both extending from a base 104.

The first projecting element 110 and the second projecting element 120 are separated by a receiving space 130. The first projecting element 110 includes a first internal wall 114. The second projecting element 120 includes a second internal wall 124, facing the first internal wall 114. The first and second internal walls and a portion of the base 104 form the receiving space 130 of the bracket assembly 100.

In some examples of the disclosure, the first projecting element 110 includes at least one aperture configured to receive a securing element (not shown). In the example illustrated herein, the first projecting element 110 includes a first aperture 112A and a second aperture 112B. Similarly, the second projecting element 120 includes at least one aperture configured to receive a securing element (not shown). In the example illustrated herein, the second projecting element 120 includes a first aperture 122A and a second aperture 122B. The apertures may be provided to receive a securing element, such as for example, a screw, a nail, a rivet, or any other components that may be used for fastening or securing the bracket assembly to an object.

It should be understood that the bracket assembly 100 may be secured to an object by other securing means that do not necessitate an aperture. For example, a surface of the base 104 opposite from the first projecting element 110 and the second projecting element 120 may be applied to an object using double-sided adhesive pads, magnets, suction components, adhesive Velcro© tape, snap fasteners or other known types of securing elements.

FIG. 2 illustrates the bracket assembly 100 receiving at least a portion of an axle element 200, according to an example of the disclosure. The first aperture 112A of the first projecting element 110 may be configured to receive securing element 141A. In some examples, the securing element 141A can be a threaded screw. Likewise, the second aperture 112B of the first projecting element 110 may be configured to receive securing element 141B. In some examples, the securing element 141B can be a threaded screw.

Similarly, the first aperture 122A of the second projecting element 120 may be configured to receive securing element 143A. In some examples, the securing element 143A can be a threaded screw. Likewise, the second aperture 122B of the second projecting element 120 may be configured to receive securing element 143B. In some examples, the securing element 143B can be a threaded screw.

As indicated herein, the first projecting element 110 and the second projecting element 120 are separated by a receiving space 130. Thus, the first projecting element 110 and the second projecting element 120 may be dimensioned such that the receiving space 130 is configured to receive at least a portion of the axle element 200. The axle element 200 may be configured as a supporting shaft or member on or with which a wheel or a set of wheels revolves. The interior of the receiving space 130 may be configured such that there is little to no tolerance for the axle element 200. Alternatively, the receiving space 130 may be dimensioned for various size axle elements.

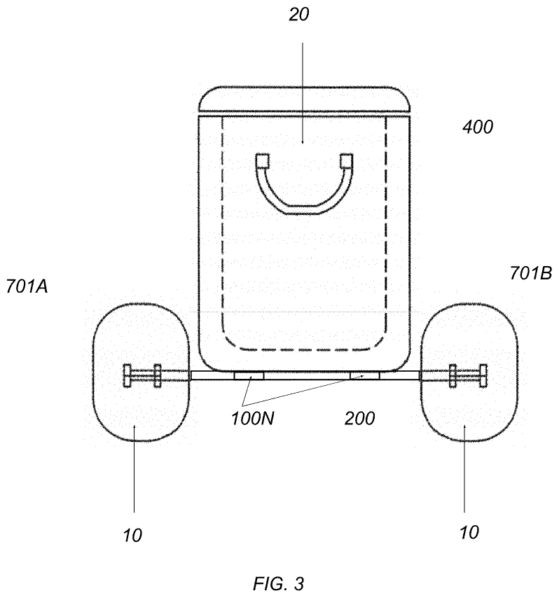

FIG. 3 illustrates configuration of a bracket assembly 100 attached to a storage device 400, according to an example of the disclosure. The storage device includes 400 includes multiple bracket assemblies 100N, configured to secure the axle element 200. The axle element 200 is attached to a first wheel 701A at a first end, and a second wheel 701B at a second opposing end. The receiving space of the bracket assemblies laterally secure the axle element 200 in place. In other words, the first and second projecting elements prevent the axle element 200 from moving along the length of the storage device 400. In addition, the weight of the storage device 400 creates a force 20, which is countered by the normal forces 10 received through the first and second wheels 701A and 701B. The forces 10 and 20 acting upon the storage device 400 secures the axle element 200 in place vertically.

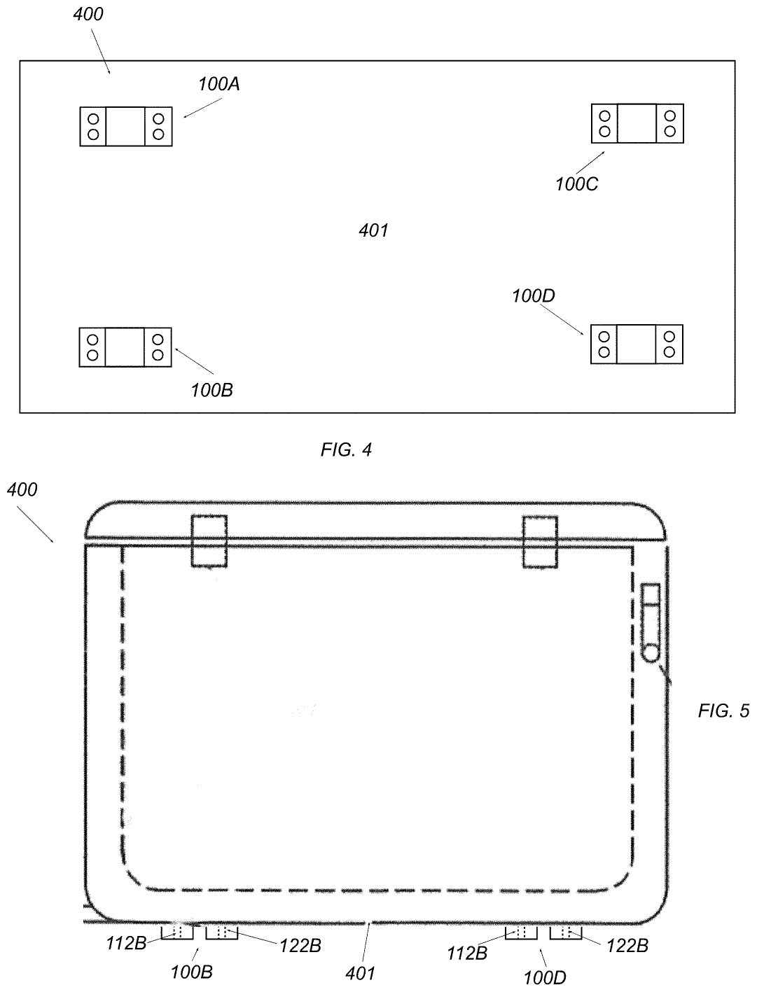

FIG. 4 illustrates an underside view of the storage device 400 and the placement of multiple bracket assemblies, according to an example of the disclosure. The storage device 400 may include an underside surface 401, which is typically parallel to a ground surface. Multiple bracket assemblies, each as described above with respect to FIG. 1, may be attached to the underside surface 401 at opposing corners. For example a first bracket assembly 100A may be attached at an upper left corner, a second bracket assembly 100B may be attached at a lower left corner. In this way, a first portion of an axle element (not shown) may be secured within the first bracket assembly 100A and a second portion of the same axle element may be secured within the second bracket assembly 100B.

While two bracket assemblies are illustrated herein to secure a first axle, it should be understood that a single bracket may be positioned within a center of the left side of the underside surface 401. The single bracket located at the center of the left side of the underside surface may secure a portion of the axle assembly configuring mobility of the storage device 400.

Furthermore, a third bracket assembly 100C may be attached at an upper right corner, a fourth bracket assembly 100D may be attached at a lower right corner. In this way, a first portion of a second axle element (not shown) may be secured within the third bracket assembly 100C and a second portion of the second axle element may be secured within the fourth bracket assembly 100D.

While two bracket assemblies are illustrated herein to secure a second axle, it should be understood that a single bracket may be positioned within a center of the right side of the underside surface 401. The single bracket located at the center of the right side of the underside surface may secure a portion of the axle assembly configuring mobility of the storage device 400.

FIG. 5 illustrates a side view of the storage device 400 with first and fourth bracket assemblies 100B and 100D attached thereto, according to an example of the disclosure. As illustrated herein, the first bracket assembly 100B may include apertures 112B and 122B configured to receive securing elements, to secure the first bracket assembly 100B to the storage device 400. The second aperture 112B is configured within the first projecting element 110 of the second bracket assembly 100B.

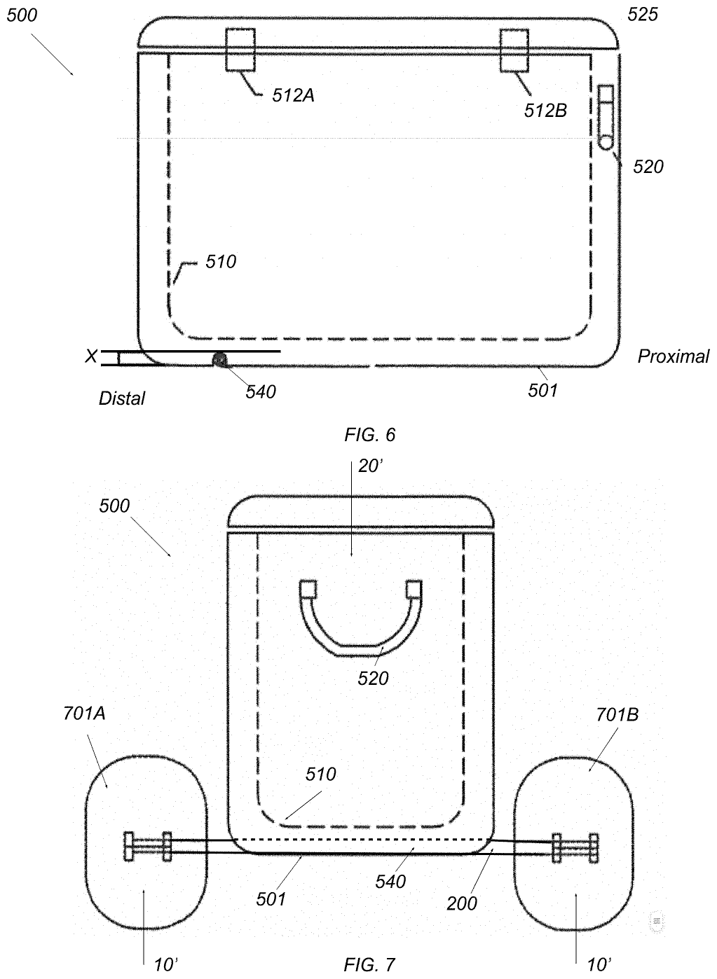

FIG. 6 is a side view of a storage device 500, according to an alternative example of the disclosure. The storage device 500 includes a cover 525 which is liftable via a first latch 512A and a second latch 512B. The storage device 500 also includes an attachment element 520, such as, for example, a rope or handle. The attachment element 520 is configured such that the weight of the storage device 500 and its contained elements may be pulled at the attachment element 520. The storage device 500 also includes an interior wall 510 and an underside surface 501. The storage device 500 includes a base thickness represented between the interior wall and the underside surface 501.

A receiving space 540 may be formed in the base thickness at the underside surface. The receiving space 540 may have a depth of X, which is less than the base thickness represented between the interior wall and the underside surface 501. The receiving space may be formed with a tolerance similar to the receiving space 130 of the bracket element 100 of FIG. 1. In this alternative example, a bracket need not be attached at each corner or in the center of the underside surface 501 of the storage device 500, as described herein. Instead, a single receiving space 540 may be formed along the width of the storage assembly 500, in the base thickness.

FIG. 7 is a front view of the storage device 500 receiving at least a portion of an axle assembly 200, according to an example of the disclosure.

The storage device includes 500 includes a receiving space 540, configured to secure the axle element 200. The axle element 200 is attached to a first wheel 701A at a first end, and a second wheel 701B at a second opposing end. The receiving space 540 of the storage device 500 laterally secure the axle element 200 in place. In other words, the receiving space 540 prevent the axle element 200 from moving along the length of the storage device 500. In addition, the weight of the storage device 500 creates a force 20′, which is countered by the normal forces 10′ received through the first and second wheels 701A and 701B. The forces 10′ and 20′ acting upon the storage device 500 secures the axle element 200 in place vertically.

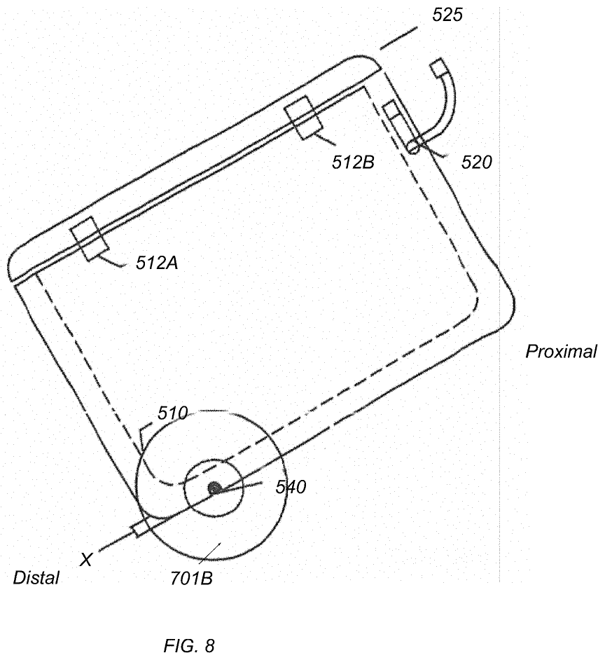

FIG. 8 is a side view of the storage device 500 receiving at least a portion of the axle assembly 200, according to an example of the disclosure. In some examples, a single receiving space 540 is formed opposite the attachment element 520, such that the attachment element 520 may be pulled or lifted at the distal end, lifting the storage element 500 at the distal end. In some alternative examples, a second receiving space may be formed opposite the receiving space 540 at the proximal end. In this alternative example, a bracket need not be attached at each corner or in the center of the underside surface 501 of the storage device 500, as described herein. Instead a receiving space may be formed along the width of the storage assembly at the proximal end, in the base thickness.

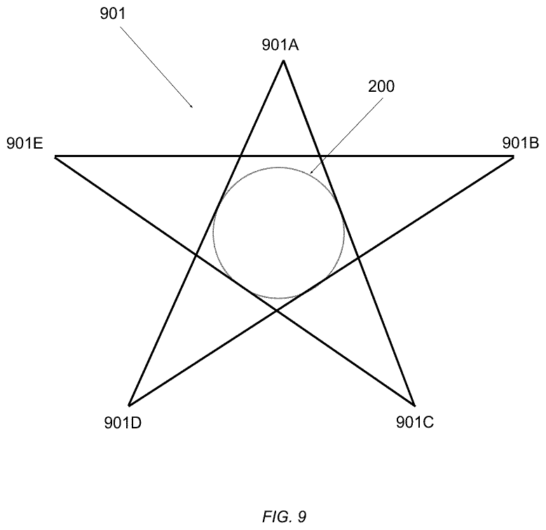

FIG. 9 illustrates an exemplary axle bracket 901, according to an example of the disclosure. The axle bracket 901 is a multi-contact bracket device configured to be mounted on an axle assembly, such as axle assembly 200 described herein. The axle bracket 901 can include four or more contact points (e.g., 901A, 901B, 901C, 901D, and 901E). In some examples, the axle bracket 901 may be configured as a star-shaped bracket.

The axle bracket 901 can include rubber pads located at each contact point. The axle bracket 901 is not configured to be mounted to an object, whose weight is placed on the axle bracket 901 and subsequently the axle assembly. Rather, the axle bracket 901 is configured such that the weight of the object contacts the axle bracket 901 on at least two of the contact points and the rubber pads generates enough friction to maintain the object in place. Unlike traditional axle brackets, which are devices used to mount an axle housing to the suspension of a vehicle, the axle bracket 901 herein provides enough surface friction to maintain an object in place while the axle assembly 200 (and connected wheels) provides mobility to the object.

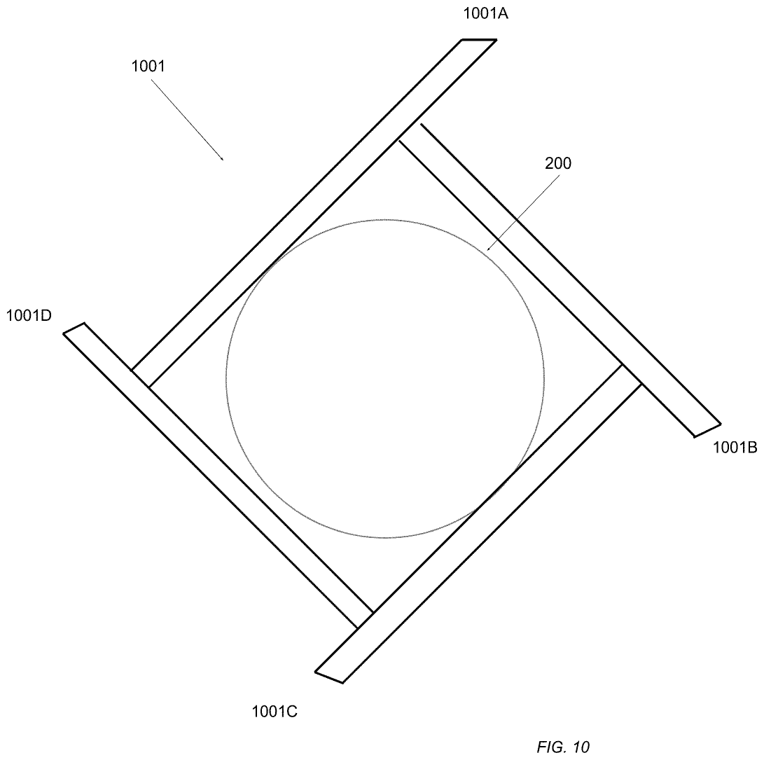

FIG. 10 illustrates an alternative exemplary axle bracket 1001, according to an example of the disclosure. The axle bracket 1001 is a multi-contact bracket device configured to be mounted on an axle assembly, such as axle assembly 200 described herein. The axle bracket 1001 can include four or more contact points (e.g., 1001A, 1001B, 1001C, and 1001D). In some examples, the axle bracket 1001 may be configured as a square-shaped bracket with protruding touch points 1001A, 1001B, 1001C, and 1001D extending from the the axle assembly 200 passing therethrough.

The axle bracket 1001 can include rubber pads located at each contact point. The axle bracket 1001 is not configured to be mounted to an object, whose weight is placed on the axle bracket 1001 and subsequently the axle assembly. Rather, the axle bracket 1001 is configured such that the weight of the object contacts the axle bracket 1001 on at least two of the contact points and the rubber pads generates enough friction to maintain the object in place. Unlike traditional axle brackets, which are devices used to mount an axle housing to the suspension of a vehicle, the axle bracket 1001 herein provides enough surface friction to maintain an object in place while the axle assembly 200 (and connected wheels) provides mobility to the object.

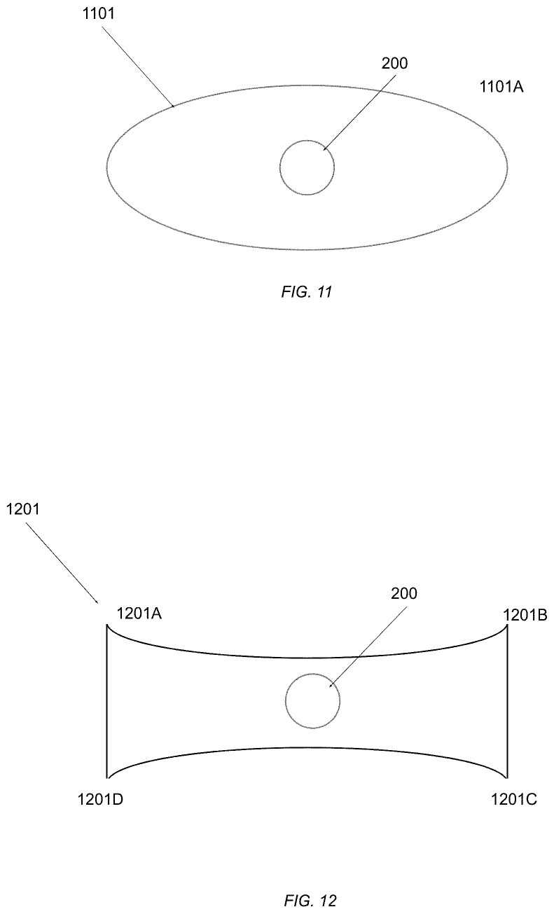

FIG. 11 illustrates an alternative exemplary axle bracket 1101, according to an example of the disclosure. The axle bracket 1101 is an elliptical shaped bracket device configured to be mounted on an axle assembly, such as axle assembly 200 described herein. The axle bracket 1101 can include a rounded surface 1101A with unlimited contact points (e.g., 1101A). In some examples, the axle bracket 1101 include an aperture such that the axle assembly 200 is able to pass therethrough.

The axle bracket 1101 can include a rubber surface at the rounded surface 1101A. The axle bracket 1101 is not configured to be mounted to an object, whose weight is placed on the axle bracket 1101 and subsequently the axle assembly. Rather, the axle bracket 1101 is configured such that the weight of the object contacts the axle bracket 1101 on at least the the rounded surface 1101A and the rubber surface generates enough friction to maintain the object in place. Unlike traditional axle brackets, which are devices used to mount an axle housing to the suspension of a vehicle, the axle bracket 1101 herein provides enough surface friction to maintain an object in place while the axle assembly 200 (and connected wheels) provides mobility to the object.

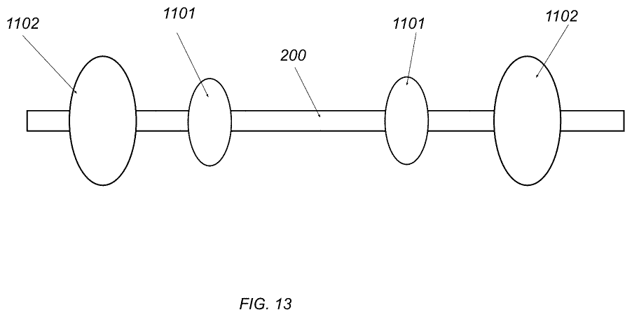

Referring momentarily to FIG. 13, which illustrates an axle assembly 200 with more than one axle bracket 1101 mounted thereon, according to an example of the disclosure. For the purposes of this example, the axle assembly 200 may include at least one elliptical shaped axle bracket 1101 in the center and two larger elliptical shaped axle brackets 1102 at the outer axle assembly 200. The orientation of the elliptical shaped axle brackets allow for the reception of a large object that may have a rounded surface. The smaller elliptical shaped axle brackets 1101 enable the protruding curvature of the object to be received, while the larger axle brackets 1102 secure the object in place.

FIG. 12 illustrates an alternative exemplary axle bracket 1201, according to an example of the disclosure. The axle bracket 1201 is a quadratic shaped bracket device with elliptical shaped sides configured to be mounted on an axle assembly, such as axle assembly 200 described herein. The axle bracket 1201 can include a first rounded surface 1202A, and a second rounded surface 1202B. The first and second rounded surfaces 1202A, 1202B may include rubber surfaces configured to generate friction. The axle bracket 1201 can also include four or more contact points (e.g., 1201A, 1201B, 1201C, and 1201D).

The axle bracket 1201 can include rubber pads located at each contact point. The axle bracket 1201 is not configured to be mounted to an object, whose weight is placed on the axle bracket 1201 and subsequently the axle assembly 200. Rather, the axle bracket 1201 is configured such that the weight of the object contacts the axle bracket 1201 on at least two of the contact points and the rubber pads generates enough friction to maintain the object in place. A curved object may also be received in the first and second rounded surfaces 1202A and 1202B, as described above with respect to FIGS. 11 and 13. Unlike traditional axle brackets, which are devices used to mount an axle housing to the suspension of a vehicle, the axle bracket 1201 herein provides enough surface friction to maintain an object in place while the axle assembly 200 (and connected wheels) provides mobility to the object.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention.

What is claimed is:

1. A bracket assembly comprising
a first projecting element extending from a base; and
a second projecting element extending from the base, the first projecting element and the second projecting element are separated by a receiving space configured to receive a portion of an axle element.

2. The bracket assembly of claim 1, wherein, the first projecting element includes a first internal wall
wherein, the second projecting element includes a second internal wall, facing the first internal wall of the first projecting element.

3. The bracket assembly of claim 2, wherein the first and second internal walls and a portion of the base form the receiving space of the bracket assembly.

4. The bracket assembly of claim 1, wherein the first projecting element includes at least one aperture configured to receive a securing element.

5. The bracket assembly of claim 1, wherein, the second projecting element includes at least one aperture configured to receive a securing element.

6. The bracket assembly of claim 1, further comprising an axle bracket configured with at least one contact point, the at least one contact point comprising a friction surface.

7. A storage device element comprising:
an attachment element;
an underside surface; and
at least one bracket assembly attached to the underside surface, to at least one bracket assembly comprising:
a first projecting element extending from a base; and
a second projecting element 120 extending from the base, the first projecting element and the second projecting element are separated by a receiving space.

8. The storage device element of claim 7, wherein, the first projecting element includes a first internal wall
wherein, the second projecting element includes a second internal wall, facing the first internal wall of the first projecting element.

9. The storage device element of claim 8, wherein the first and second internal walls and a portion of the base form the receiving space of the bracket assembly.

10. The storage device element of claim 7, wherein the first projecting element includes at least one aperture configured to receive a securing element.

11. The storage device element of claim 10, wherein the securing element includes at least one of a screw, a nail, a rivet for attaching the at least one bracket assembly to the underside surface of the storage container.

12. The storage device element of claim 7, wherein, the second projecting element includes at least one aperture configured to receive a securing element.

13. The storage device element of claim 12, wherein the securing element includes at least one of a screw, a nail, a rivet for attaching the at least one bracket assembly to the underside surface of the storage container.

14. The storage device element of claim 7, wherein a surface of the base of the bracket assembly, opposite the first projecting element and the second projecting element is attached to the storage container using at least one of double-sided adhesive pads, magnets, suction components, adhesive Velcro© tape, snap fasteners.

15. The storage device element of claim 7, further comprising an axle element, wherein the at least one bracket assembly is configured to receive at least a portion of the axle element.

16. The storage device element of claim 7, wherein the at least one bracket assembly includes four bracket assemblies attached to the underside surface of the storage container at opposing corners.

17. The storage device element of claim 16, wherein a first pair of the four bracket assemblies are aligned to receive a first axle assembly, and a second pair of the four bracket assemblies are aligned to receive a second axle assembly.

18. The storage device element of claim 7, wherein the at least one bracket assembly includes a first bracket assembly at a proximal end and a second bracket assembly at a distal end of the underside surface of the storage container.

19. The storage device element of claim 7, further comprising an axle bracket configured with at least one contact point, the at least one contact point comprising a friction surface.

20. The storage device element of claim 7, further comprising an elliptical shaped axle bracket configured with at least one contact point, the at least one contact point comprising a friction surface.
